(19) United States
(12) Patent Application Publication
(10) Pub. No.: US 2008/0240116 A1
(43) Pub. Date: Oct. 2, 2008

(54) Method and Apparatus for Determining the Locating of Nodes in a Wireless Network

(75) Inventors: Feng Niu, Weston, FL (US); Timothy J. Bancroft, Boca Raton, FL (US); Robert J. O'Dea, Fort Lauderdale, FL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/691,066

(22) Filed: Mar. 26, 2007

(51) Int. Cl. H04Q 7/00; H04L 12/56

(52) U.S. Cl. 370/400; 370/328

(57) ABSTRACT

A method and apparatus for determining the relative locations of nodes in a wireless network is disclosed. A list of neighboring nodes of a master node of the wireless network is generated and, from this list, a list of independent nodes is generated. An adjacency table for the independent nodes is then generated by examining the neighbors of dependent nodes. Two independent nodes are determined to be adjacent nodes only if they are the only neighboring nodes of a dependent node. Relative locations of nodes in wireless network may be determined from the adjacency table.

### FIELD OF THE INVENTION

The present invention relates generally to radio location and, in particular, to a method and apparatus for determining the location of nodes within a wireless communication network.

### BACKGROUND

Many large wireless networks are composed of multiple sub-networks. An example of a sub-network is a ‘piconet’ or Personal Area Network (PAN), in which radio communication is performed in accordance with the Bluetooth protocol.

In many applications with large wireless networks having at most one reference node in each piconet, there is a need to know the relative locations of the nodes within a piconet. Once this information is obtained, is it easier to locate a node in the wireless network with multiple piconets and also to route information in the network. Traditional location technology is not well suited for enabling a node in a piconet to discover its location relative to peer nodes in the same piconet. Even when this technology can be used, it requires extensive computation to solve the associated equations and generally requires some pre-deployment characterization of the environment. The pre-deployment characterization may not be practical in many applications, especially those with changing environments. The only simple method requiring no pre-deployment measurements is the proximity method, which requires ‘proximity’ of the node to the reference nodes. If a node is linked to at most one reference node, the proximity method uses the reference node location as the estimated location of the node. This does not help finding the relative locations of the nodes in a piconet.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is flow chart of a method for identifying relative locations of nodes in a wireless network, in accordance with some embodiments of the invention.

FIG. 2 is flow chart of a method for identifying a set of independent nodes in a wireless network, in accordance with some embodiments of the invention.

FIG. 3 is an exemplary wireless network showing independent nodes in accordance with some embodiments of the invention.

FIG. 4 is an exemplary table of node properties in accordance with some embodiments of the invention.

FIG. 5 is an exemplary node ranking list in accordance with some embodiments of the invention.

FIG. 6 is an exemplary table of independent nodes identified in accordance with some embodiments of the invention.

### DETAILED DESCRIPTION

Before describing in detail embodiments that are in accordance with the present invention, it should be observed that the embodiments reside primarily in combinations of method steps and apparatus components related to node location in a wireless network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions of node location in a wireless network described herein. The non-processor circuits may include, but are not limited to, a radio receiver, a radio transmitter, signal drivers, clock circuits, power source circuits, and user input devices. As such, these functions may be interpreted as a method to perform node location in a wireless network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to a method and apparatus for determining the relative locations of nodes in a wireless network, such as a piconet, without any need for pre-deployment measurement or equation solving.

The invention is described below with reference to an embodiment in a piconet. However, the invention is not limited to piconets and may be used in other wireless networks.

The present invention relates to a method and apparatus for determining the relative locations of nodes in a wireless network. In accordance with one embodiment of the method, a list of neighboring nodes of a master node of the wireless network is generated and, from this list, a list of independent nodes is generated. An adjacency table for the independent nodes is then generated by examining the neighbors of dependent nodes. Two independent nodes are determined to be adjacent nodes only if they are the only neighboring nodes of a dependent node. Relative locations of nodes in wireless network may be determined from the adjacency table. The list of independent nodes may be generated by generating a ranking list of nodes in the list of neighboring nodes and then, for each successively selected node in the ranking list, determining the selected node to be an independent node if no other independent node is a neighbor of the selected node.

In one embodiment, the ranking list of nodes in the list of neighboring nodes may be generated by, for each selected node of the list of neighboring nodes of the master node, determining the number of nodes that are neighbors of both the selected node and the master node and then ranking the list of nodes in the list of neighboring nodes in accordance to the number of nodes that are neighbors of both the selected node and the master node. A node having the smallest number of nodes that are neighbors of both the selected node and the master node is positioned first in the ranking list.

In a further embodiment, the ranking list of nodes in the list of neighboring nodes is generated by, for each selected node of the list of neighboring nodes of the master node, determining the path loss between the selected node and the master node and ranking the list of nodes in the list of neighboring nodes in accordance to the path loss between the selected node and the master node. A node having the largest path loss is positioned first in the ranking list.

The invention also relates to a method for determining relative locations of nodes in wireless network. The method includes (1) generating a list of neighboring nodes of a master node of the wireless network, (2) generating, from the list of neighboring nodes, a list of independent nodes and (3) a first neighboring node of the master node determining its relative location by determining which independent nodes are neighboring nodes. The master node may transmit the list of independent node to the first neighboring node.

The present invention also relates to a wireless network that has a master node and a set of neighboring nodes, operable to communicate with the master node. The master node is operable to select, from the set of neighboring nodes, a set of independent nodes, where no independent node is a neighbor of any other independent node and to determine which nodes of the set of independent nodes are adjacent to one another. The master node may also be operable to determine the relative location a selected node of the set of neighboring nodes by determining which independent nodes are neighbors of the selected node. In addition, a node of the set of neighboring nodes may be operable to determine its own relative location, in the network, by determining which independent nodes are its neighbors.

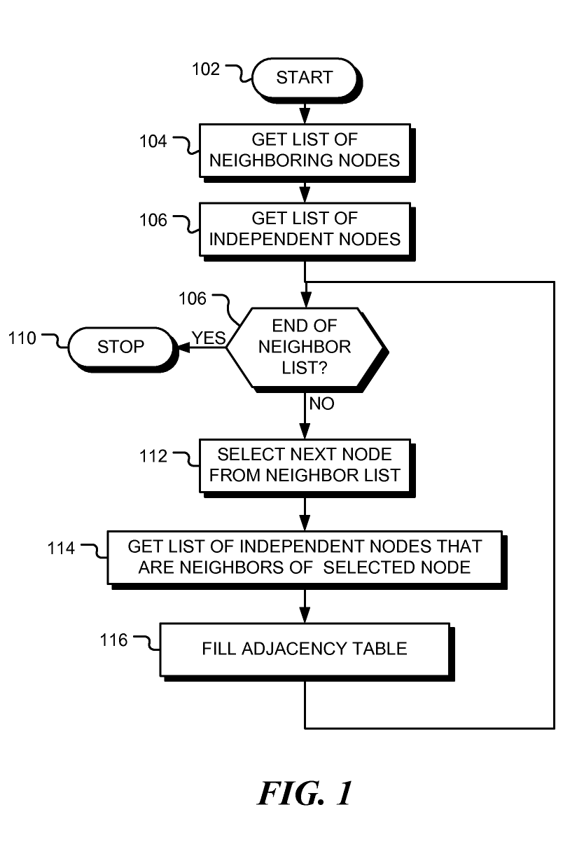

A piconet has a ‘star’ structure, with each node able to communicate directly with a master node, also called the piconet controller (PNC). In the description below, the master node is designated as node ND1. The nodes in direct communication with the master node are called neighboring nodes, or simply ‘neighbors’, of the master node. The location of the master node may or may not be known. During normal operation of the network, each node in the piconet establishes a neighbor list as part of networking requirements. Once the neighbor lists are established, relative locations of the nodes in the network can be identified as shown in the flow chart of FIG. 1.

FIG. 1 is flow chart of a method for determining the relative locations nodes in a wireless network, in accordance with some embodiments of the invention. Referring to FIG. 1, following start block 102, the master node ND1, gets a list of its neighboring nodes at block 104. At block 106, the master mode forms a list of independent nodes in the piconet. An independent node is a node with no other independent nodes (apart from the master node) on its neighbor list. Determination of this list is discussed in more detail below. The n−1 independent nodes are designated as the set {ND2, ND3, . . . , NDn}. The master node ND1 then selects nodes from the neighbor list (the list of neighboring nodes) in turn and queries each node to discover which independent nodes are its neighbors. At decision block 106, the master node ND1 checks to see if the end of the list of neighboring nodes has been reached. If the end of the neighbor list has been reached, as depicted by the positive branch from decision block 106, the process terminates at block 110. If the end of the neighbor list has not been reached, as depicted by the positive branch from decision block 106, the node ND1 selects the next neighbor node from the neighbor list at block 112. At block 114, the mode ND1 communicates with the selected node to determine which independent nodes are neighbors of the selected node. At block 116 the node ND1 uses this information to fill in an adjacency table for the independent nodes. Two independent nodes are determined to be adjacent if they are the only two independent nodes that are neighbors of the selected node. That is, if the selected node has two and only two nodes from the independent node set {ND2, ND3, . . . , NDn} as its neighbors, those two independent nodes will be considered adjacent to each other. For example, if ND2 and ND4 are neighbors of a node and no other independent nodes are neighbors of that node, ND2 and ND4 are adjacent to each other. The master node ND1 fills the adjacency table for independent nodes by examining the nodes with only two independent nodes on its neighbor list. An example of an adjacency table is shown as table 1 below.

TABLE 1

| | ND2 | ND3 | ND4 | ND5 | ND6 |
|---|---|---|---|---|---|
| ND2 | n/a | 1 | 0 | 1 | 0 |
| ND3 | 1 | n/a | 1 | 0 | 0 |
| ND4 | 0 | 1 | n/a | 0 | 1 |
| ND5 | 1 | 0 | 0 | n/a | 1 |
| ND6 | 0 | 0 | 1 | 1 | n/a |

Note that table is symmetric, so only the upper or lower triangular section needs to be filled and/or stored.

In the adjacency table, a value ‘1’ indicates that the nodes are adjacent and a value ‘0’ indicates that the nodes are not adjacent.

The node ND1 can determine each node's relative location or relative orientation from the adjacency table.

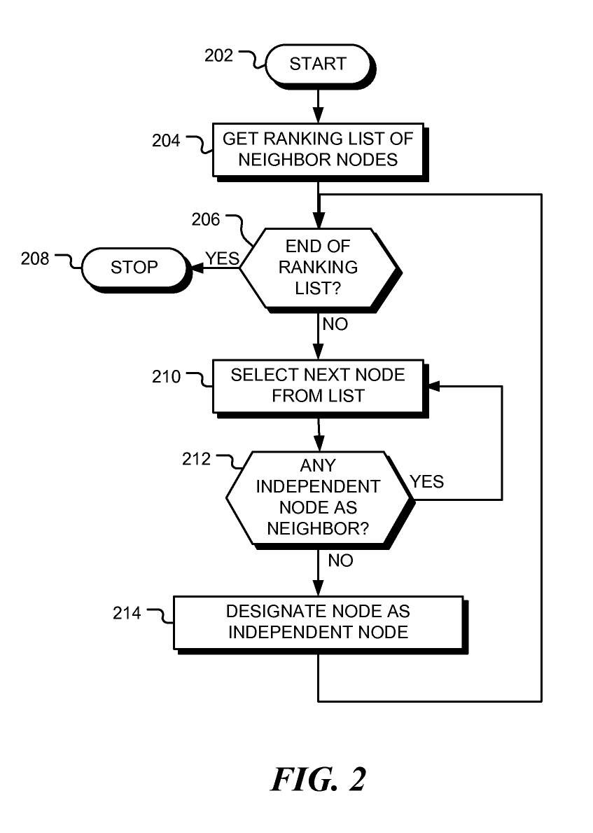

FIG. 2 is flow chart of a method for identifying a set of independent nodes in a wireless network, in accordance with some embodiments of the invention. Referring to FIG. 2, following start block 202, the master node ND1, at block 204, forms a ranking list by ranking its neighbors. In a first embodiment of the invention, the ranking is determined by the number of neighbors each node has in common with ND1. The node with the least number of common neighbors is placed first in the list. In a further embodiment, the ranking is determined by the path loss. Path loss is commonly measured by comparing the power of an ‘over-the-air’ signal transmitted from one node to the corresponding power received at another node. A weaker signal implies greater path loss. Other, indirect, measures of path loss (such as error rates) may be used. The node with the highest path loss is placed first in the list. In both of these embodiments, the most ‘remote’ node is placed first in the ranking list. It will be apparent to those of ordinary skill in the art that other measures of remoteness may be used and that such measures may be used in combination. At block decision block 206, ND1 checks to see if the list is empty, that is, if the master node has no neighbors. If the list is empty as determined by the positive branch from decision block 206, the process terminates at block 208, since there are no nodes to locate. If the list is not empty, as determined by the negative branch from decision block 206, the first node in the ranking list is selected at block 210. If several of ND1 's neighbors have the same ranking, ND1 will pick one of them (the selection may be made at random or in accordance with a predetermined selection scheme such as lowest ID number). At block 212 a check is made to determine if the selected node has any independent node as a neighbor. Since no independent nodes have been found yet, flow continues to block 214 and the first node in the ranking list is selected as an independent node. Flow then returns to decision block 206, where the master node ND1 determines if the end of the ranking list has been reached yet. If not, as determined by the negative branch from decision block 206, ND1 selects the next node in the ranking list at block 210. At decision block 212 the node ND1 asks the selected node if any of the independent nodes (currently just ND2) is a neighbor. If ND2 is not its neighbor, as depicted by the negative branch from decision block 212, this node becomes is designated as an independent node at block 214, and is designated ND3. However, if the independent node ND2 is a neighbor of the selected node, as depicted by the positive branch from decision block 212, flow returns to decision block 206 and node ND1 will continue down its ranking list and pick at block 210 the node having the next highest ranking. This process continues until ND1 exhausts all its neighbors and the end of the ranking list is reached. The process then terminates at block 208.

At the end of the process, the node ND1 will have found n−1 mutually ‘independent’ neighbors, ND2, ND3, . . . , NDn, with the property that they are not neighbors of each other but together their neighbors cover all the neighbors of ND1. The set {ND2, ND3, . . . , NDn} is called the independent node set and any node in this set is called an independent node.

Any node in the network can determine its relative location by looking at which independent nodes are on its neighbor list.

The determination of relative locations of nodes in wireless network is begun by generating a list of neighboring nodes of a master node of the wireless network and generating, from the list of neighboring nodes, a list of independent nodes. An adjacency table for the independent nodes is then generated by examining the neighbors of dependent nodes. Two independent nodes are determined to be adjacent nodes if only if they are the only neighboring nodes of a dependent node. Relative locations of nodes in wireless network are determined from the adjacency table.

The list of independent nodes may be formed by generating a ranking list of nodes in the list of neighboring nodes, and, for each successively selected node in the ranking list, determining the selected node to be an independent node if no other independent node is a neighbor of the selected node.

The ranking list of nodes in the list of neighboring nodes may be generated by, for each selected node of the list of neighboring nodes of the master node, determining the number of nodes that are neighbors of both the selected node and the master node, and ranking the list of nodes in the list of neighboring nodes in accordance to the number of nodes that are neighbors of both the selected node and the master node. A node having the smallest number of nodes that are neighbors of both the selected node and the master node is positioned first in the ranking list.

In a further embodiment the ranking list of nodes in the list of neighboring nodes is generated by, for each selected node of the list of neighboring nodes of the master node, determining the path loss between the selected node and the master node, and ranking the list of nodes in the list of neighboring nodes in accordance to the path loss between the selected node and the master node. A node having the largest path loss is positioned first in the ranking list.

A neighboring node of the master node may determine its relative location by determining which independent nodes are neighboring nodes. The list of independent nodes may be transmitted from the master node to the neighboring node.

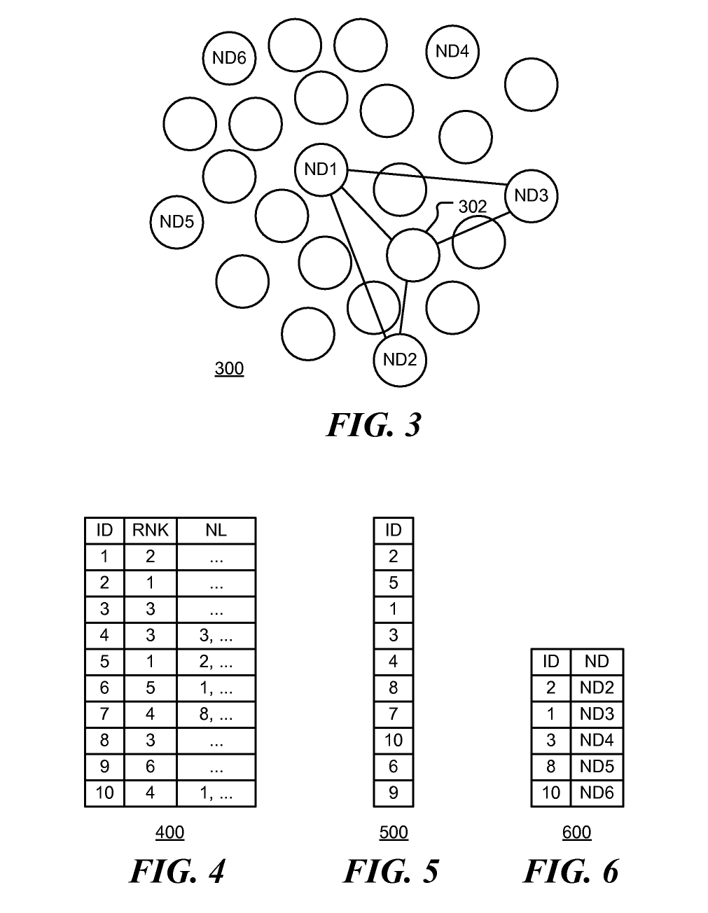

An exemplary network illustrating independent nodes is shown in FIG. 3. Each node in FIG. 3 is network node having processing logic and a radio transceiver to allow it to communicate with at least one other node in the network. Referring to FIG. 3, the node ND1 is a master or controlling node for the network 300. The nodes in the set {ND2, ND3, ND4, ND5, ND6} have been selected as independent nodes in accordance with the method described above. A corresponding adjacency table is shown as table 1 above. In this network, node ND4 is adjacent to nodes ND3 and ND6, for example. Most network connections are omitted from the figure for simplicity. A node can determine its relative position by examining its neighbor list to determine which independent nodes are present. In this example, node 302 can determine that independent nodes ND2 and ND3 are in its neighbor list.

FIG. 4 is an exemplary table showing properties of neighboring nodes of a master node in a network. The first column (labeled ‘ID’) of the table 400 indicates the node identifier and the second column indicates the ranking measure of the node. In this example, the ranking measure is the number of nodes in common with the master node. Thus, node 1 has two nodes in common, while node 2 has only 1 node in common and node 9 has six nodes in common. The third column in the table 400 (labeled ‘NL’) indicates the neighbor list of the node.

FIG. 5 is an exemplary ranking list in accordance with some embodiments of the invention. Referring to FIG. 5, the ranking list 500 lists the node identifiers in ranked order, according to which node has the least number of neighbors in common with the master node. Node 2 is listed first since it only has 1 node in common (see table 400 in FIG. 4). Node 5 could also have been placed first since it also has only one node in common. Node 9 is last in the list since it has the highest number of nodes in common.

FIG. 6 is a table of independent nodes identified in accordance with the methods described above. The table 600 shows that node 2 has been designated as ND2 since it was first in the ranking list. Node 1 has been selected as ND3, even though it was not next in the ranking list. This is because node 5 has independent node 2 (ND2) as its neighbor, as indicated in the third column of table 400 in FIG. 4, and is not independent. Similarly, node 4 was not selected because it has node 3 (ND4) as its neighbor.

The adjacency table for the network is determined by asking each node if any of the independent nodes is a neighbor. The adjacency table may then be used to determine relative locations of nodes in the network.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for determining relative locations of nodes in wireless network, the method comprising:
generating a list of neighboring nodes of a master node of the wireless network;
generating, from the list of neighboring nodes, a list of independent nodes;
for each selected node of the list of neighboring nodes that is not an independent node:
determining two independent nodes to be adjacent nodes if only if they are the only neighboring nodes of the selected node;
generating an adjacency table for the independent nodes; and
determining relative locations of nodes in wireless network from the adjacency table.

2. A method in accordance with claim 1, wherein generating the list of independent nodes comprises:
generating a ranking list of nodes in the list of neighboring nodes; and
for each successively selected node in the ranking list:
determining the selected node to be an independent node if no other independent node is a neighbor of the selected node.

3. A method in accordance with claim 2, wherein generating a ranking list of nodes in the list of neighboring nodes comprises:
for each selected node of the list of neighboring nodes of the master node:
determining the number of nodes that are neighbors of both the selected node and the master node; and
ranking the list of nodes in the list of neighboring nodes in accordance to the number of nodes that are neighbors of both the selected node and the master node, wherein a node having the smallest number of nodes that are neighbors of both the selected node and the master node is positioned first in the ranking list.

4. A method in accordance with claim 2, wherein generating a ranking list of nodes in the list of neighboring nodes comprises:
for each selected node of the list of neighboring nodes of the master node:
determining the path loss between the selected node and the master node; and
ranking the list of nodes in the list of neighboring nodes in accordance to the path loss between the selected node and the master node,
wherein a node having the largest path loss is positioned first in the ranking list.

5. A method for determining relative locations of nodes in wireless network, the method comprising:
generating a list of neighboring nodes of a master node of the wireless network;
generating, from the list of neighboring nodes, a list of independent nodes;
a first neighboring node of the master node determining its relative location by determining which independent nodes are neighboring nodes.

6. A method in accordance claim 5, wherein generating a list of neighboring nodes of the master node of the wireless network and generating, from the list of neighboring nodes, a list of independent nodes is performed by the master node, the method further comprising:
the master node transmitting the list of independent node to the first neighboring node.

7. A method in accordance with claim 5, wherein generating the list of independent nodes comprises:
generating a ranking list of nodes in the list of neighboring nodes; and
for each successively selected node in the ranking list:
determining the selected node to be an independent node if no independent node is a neighbor of the selected node.

8. A method in accordance with claim 7, wherein generating a ranking list of nodes in the list of neighboring nodes comprises:
for each selected node of the list of neighboring nodes of the master node:
determining the number of nodes that are neighbors of both the selected node and the master node; and
ranking the list of nodes in the list of neighboring nodes in accordance to the number of nodes that are neighbors of both the selected node and the master node, wherein a node having the smallest number of nodes that are neighbors of both the selected node and the master node is positioned first in the ranking list.

9. A method in accordance with claim 7, wherein generating a ranking list of nodes in the list of neighboring nodes comprises:
for each selected node of the list of neighboring nodes of the master node:
determining the path loss between the selected node and the master node; and
ranking the list of nodes in the list of neighboring nodes in accordance to the path loss between the selected node and the master node,
wherein a node having the largest path loss is positioned first in the ranking list.

10. A wireless network comprising:
a master node;
a set of neighboring nodes, operable to communicate with the master node;
wherein the master node is operable to:
select, from the set of neighboring nodes, a set of independent nodes, where no independent node is a neighbor of any other independent node;
determine which nodes of the set of independent nodes are adjacent to one another; and
determine the relative location a selected node of the set of neighboring nodes by determining which independent nodes are neighbors of the selected node.

11. A wireless network in accordance with claim 10, wherein the wireless network comprises a piconet.

12. A wireless network in accordance with claim 10, wherein the master mode is further operable to select the set of independent nodes by:
generating a ranking list of neighboring nodes; and
for each successively selected node in the ranking list:
determining the selected node to be an independent node if no other independent node is a neighbor of the selected node.

13. A wireless network in accordance with claim 12, wherein the master node is further operable to determine the path loss between the master node and each neighboring node, wherein the nodes in the ranking list are ordered dependent upon the path loss.

14. A wireless network in accordance with claim 12, wherein the master node is further operable to determine the number of neighbors it has in common with each neighboring node, wherein the nodes in the ranking list are ordered dependent upon the number of common neighbors.

15. A wireless network comprising:
a master node;
a set of neighboring nodes, operable to communicate with the master node; wherein the master node is operable to:
select, from the set of neighboring nodes, a set of independent nodes, where no independent node is a neighbor of any other independent node;
determine which nodes of the set of independent nodes are adjacent to one another; and
wherein a node of the set of neighboring nodes is further operable to determine its relative location in the network by determining which independent nodes are its neighbors.

16. A wireless network in accordance with claim 15, wherein the wireless network comprises a piconet.

17. A wireless network in accordance with claim 15, wherein the master mode is further operable to select the set of independent nodes by:
generating a ranking list of neighboring nodes; and
for each successively selected node in the ranking list:
determining the selected node to be an independent node if no other independent node is a neighbor of the selected node.

18. A wireless network in accordance with claim 17, wherein the master node is further operable to determine the path loss between the master node and each neighboring node, wherein the nodes in the ranking list are ordered dependent upon the path loss.

19. A wireless network in accordance with claim 17, wherein the master node is further operable to determine the number of neighbors it has in common with each neighboring node, and wherein the nodes in the ranking list are ordered dependent upon the number of common neighbors.
